(19) United States
(12) Patent Application Publication
(10) Pub. No.: US 2023/0105663 A1
(43) Pub. Date: Apr. 6, 2023

(54) SELECTIVE COATINGS FOR HYDROPHOBIC SURFACES AND METHODS OF MANUFACTURE THEREFOR

(71) Applicant: Lotus Leaf Coatings, Inc., Albuquerque, NM (US)

(72) Inventors: Lawrence Chavez, Albuquerque, NM (US); Jan-Michael Gosau, Albuquerque, NM (US); Christopher Sanchez, Albuquerque, NM (US)

(73) Assignee: Lotus Leaf Coatings, Inc., Albuquerque, NM (US)

(21) Appl. No.: 18/078,053

(22) Filed: Dec. 8, 2022

Related U.S. Application Data
(63) Continuation of application No. 16/537,458, filed on Aug. 9, 2019, now abandoned.
Application No. 16/537,458 is a continuation-in-part of application No. 15/440,776, filed on Feb. 23, 2017, now abandoned.
(60) Provisional application No. 62/716,795, filed on Aug. 9, 2018.
(60) Provisional application No. 62/298,573, filed on Feb. 23, 2016.
(60) Provisional application No. 62/314,566, filed on Mar. 29, 2016.

(51) Int. Cl. C09D 5/00; C09D 183/08; C09D 183/06; C09D 7/40; G02B 1/18

(52) U.S. Cl. CPC C09D 5/00; C09D 183/08; C09D 183/06; C09D 7/68; G02B 1/18; C09D 7/67; G02C 7/04

(57) ABSTRACT

Compositions for rendering a hydrophobic surface hydrophilic and methods for manufacturing them and applying them to objects such as contact lenses. A hydrophobic binder, typically a silicone compound such as a siloxane, selectively attaches hydrophilic solution-produced nanoparticles to the surface, such as hydrophobic regions of a silicone contact lens. Hydrophilic regions are preferably unmodified. The binder attaches to the particles via functional groups in solution and can autoadhere to the hydrophobic surface. A coating of the composition can be deposited from solution at ambient or room temperature, allowing coating of temperature sensitive substrates. Such coatings can withstand heating (such as for sterilization) in acidic solutions or heat sensitive solutions, retaining their hydrophilic properties.

### CROSS-REFERENCE TO RELATED APPLICATIONS

This application is a continuation application of U.S. patent application Ser. No. 16/537,458, entitled “Selective Coatings for Hydrophobic Surfaces”, filed on Aug. 9, 2019, which application claims priority to and the benefit of the filing of U.S. Provisional Patent Application Ser. No. 62/716,795, entitled “Coatings for Contact Lenses”, filed on Aug. 9, 2018, and which application is also a continuation-in-part of U.S. patent application Ser. No. 15/440,776, entitled “Sol-Gel Coatings for Contact Lenses”, filed on Feb. 23, 2017, which application claims priority to and the benefit of the filing of U.S. Provisional Patent Application Ser. No. 62/298,573, entitled “Sol-Gel Coatings for Siloxane-Containing Contact Lenses”, filed on Feb. 23, 2016, and U.S. Provisional Patent Application Ser. No. 62/314,566, entitled “Sol-Gel Coatings for Siloxane-Containing Contact Lenses”, filed on Mar. 29, 2016. The specifications and claims of these applications are incorporated herein by reference.

### BACKGROUND OF THE INVENTION

### Field of the Invention (Technical Field)

The present invention relates to surface treatments for contact lenses, in particular for treatment to increase the hydrophilic properties of hydrophobic regions on the surfaces of siloxane-based lenses.

### BACKGROUND ART

Note that the following discussion may refer to a number of publications and references. Discussion of such publications herein is given for more complete background of the scientific principles and is not to be construed as an admission that such publications are prior art for patentability determination purposes.

Modern silicone hydrogel contact lenses are typically produced from polydimethylsiloxane or other siloxanes as base material due to the high oxygen permeability of the polymer. Unfortunately, the base material is highly hydrophobic and is not wetted by the tear fluid of the eye. This aggravates the user and makes the unmodified base material unusable as contact lens material. To improve the wear comfort of the lenses, the base material is most often converted to an interpenetrating network with a highly hydrophilic second polymer, typically described as a hydrogel. This silicone hydrogel material allows the finished lens to absorb up to 50% water and be acceptable to the user. Unfortunately, as shown in FIG. 1, the surface of the lens still comprises both hydrophilic regions 10 (where the hydrogel is exposed) and hydrophobic regions 20 comprising the surface siloxane. This limits the user comfort. There is, therefore, an unmet need for a surface treatment that can permanently coat only the hydrophobic regions of the lens with a hydrophilic coating without influencing the rest of the properties of the lens. U.S. Pat. No. 6,126,733 (Wallace et al) teaches compositions with hydrophilic character, wherein the films rely on high boiling solvents to achieve their properties upon evaporation.

### SUMMARY OF THE INVENTION (DISCLOSURE OF THE INVENTION)

An embodiment of the present invention is a composition comprising a coating that selectively binds to hydrophobic regions of a contact lens via interactions with nanoparticles in the composition incorporating the use of hydrophilic tails and hydrophobic binders. The hydrophobic binders are capable of binding the nanoparticles selectively to a hydrophobic surface. The nanoparticles preferably comprise both a hydrophobic binder and a hydrophilic tail. The hydrophobic binder preferably comprises a silicone compound, more preferably a siloxane oligomer. The hydrophobic binder preferably comprises one or more functional groups, which are preferably each selected from the group consisting of a hydride, amino, amine, hydroxyl, epoxy, vinyl, acrylate, and mercapto group. The hydrophilic tails are preferably derived from a metal alkoxide precursor comprising one or more functional groups each selected from the group consisting of an epoxy, carboxylic acid, vinyl, acrylate, or amino group. The functional group optionally comprises 3-glycidylpropylsiloxane.

Another embodiment of the present invention is an article comprising a coating comprising the composition described above. The article preferably comprises a contact lens. The coating preferably has a thickness less than one micron, more preferably between 50 and 500 nm. The coating is preferably bound only to first regions of the article, for example regions which were hydrophobic prior to coating with the coating. The surfaces of the first regions preferably comprise a siloxane such as polydimethylsiloxane resin. Regions of the article not comprising the first regions were preferably hydrophilic prior to coating with the coating. The coating was preferably deposited on the first regions from solution, preferably at no higher than ambient temperature, since the article might optionally be damaged if heated to a temperature above ambient temperature. The article is preferably stored in an acidic solution, which preferably comprises low pH distilled water, low pH saline or a heat sensitive buffer. The buffer preferably comprises Tris(hydroxymethyl)aminomethane (TRIS). The buffer optionally releases an acid upon heating of the solution. The coating preferably remains unmodified when heated to above ambient temperature in the solution. The coating preferably remains unmodified when heated to about 120° C. in the solution. The contact angle of the coating preferably increases by less than approximately 10 degrees, or even less than approximately 5 degrees, after heating in the solution.

Another embodiment of the present invention is a composition comprising hydrophilic nanoparticles comprising first functional groups and a hydrophobic binder comprising second functional groups, the first functional groups bound to the second functional groups. The hydrophobic binder preferably comprises a silicone compound, preferably a siloxane oligomer. The second functional groups are each preferably selected from the group consisting of a hydride, amino, amine, hydroxyl, epoxy, vinyl, acrylate, and mercapto group. The nanoparticles are preferably derived from a metal alkoxide precursor comprising the first functional groups; the metal alkoxide is preferably a silicon alkoxide. Each first functional group is preferably selected from the group consisting of an epoxy, carboxylic acid, vinyl, acrylate, or amino group. The first functional groups preferably comprise an epoxy comprising 3-glycidylpropylsiloxane. The first functional groups are preferably bound to hydrophilic tails of the nanoparticles. The nanoparticles are preferably between approximately 10 nm and 200 nm in size.

Another embodiment of the present invention is an article comprising a coating comprising hydrophilic nanoparticles, the hydrophilic nanoparticles comprising first functional groups and a hydrophobic binder comprising second functional groups, the first functional groups bound to the second functional groups. The article is preferably a contact lens. The coating preferably has a thickness less than approximately one micron, more preferably between approximately 50 and 500 nm. The coating is preferably bound only to first regions of the article. The first regions were preferably hydrophobic prior to coating with the coating. The hydrophilic nanoparticles in the coating are preferably bound to the first regions via the hydrophobic binder. The hydrophobic binder preferably adheres to the first regions via diffusion of polymeric chains across the interface and entanglement of the chains. Surfaces of the first regions preferably comprise a siloxane. The siloxane typically comprises polymethylsiloxane resin. The regions of the article other than the first regions are preferably hydrophilic both prior to and after coating with the coating. The coating was preferably deposited on the first regions from solution, preferably at no higher than ambient temperature. The article may be damaged if heated to a temperature above ambient temperature. The article is preferably capable of being stored in an acidic solution. The acidic solution preferably comprises low pH distilled water or low pH saline. The coating preferably remains substantially, approximately unmodified when heated to above ambient temperature in the acidic solution. The coating preferably remains substantially, approximately unmodified when heated to about 120° C. in the acidic solution. The contact angle of the coating preferably increases by less than approximately 5 degrees after heating in the acidic solution. The nanoparticles are preferably between approximately 10 nm and 200 nm in size. The coating is preferably optically clear.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a schematic representation of surface properties of regions of a contact lens.

FIG. 2 shows a schematic of a nanoparticle comprising hydrophilic tails and hydrophobic binders.

FIG. 3A shows the nanoparticles of FIG. 2 binding to hydrophobic regions of a contact lens.

FIG. 3B shows a hydrophilic coating bound to hydrophobic regions of a contact lens

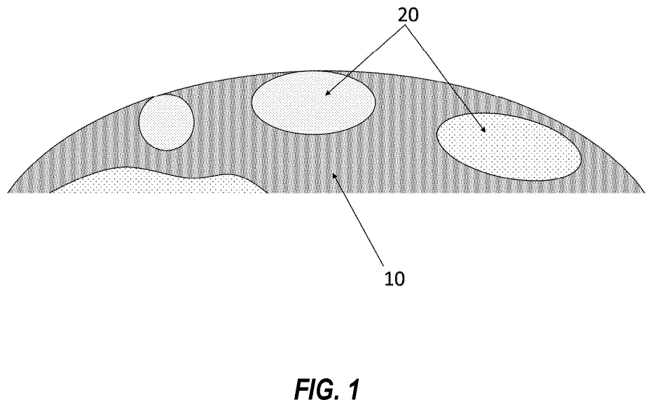

### DETAILED DESCRIPTION OF EMBODIMENTS OF THE INVENTION

Embodiments of the present invention are compositions for the production of hydrophilic coatings on a hydrophobic substrate, such as a contact lens comprising a hydrogel and a siloxane, the compositions comprising at least one hydrolyzed metal alkoxide comprising a functional group reacted with at least one functionalized siloxane oligomer or polymer capable of reacting with the alkoxide functional group. The alkoxide can be functionalized with an epoxy, carboxyl acid, vinyl, acrylate, or amino group. The siloxane can be functionalized with a hydride or with an amino, hydroxyl, epoxy, vinyl, acrylate, or mercapto group.

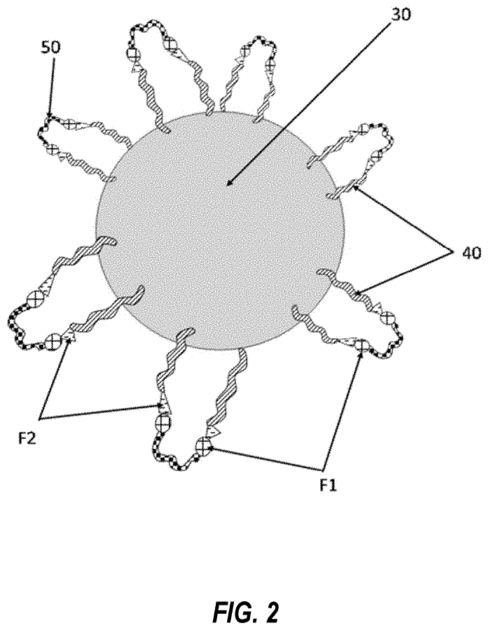

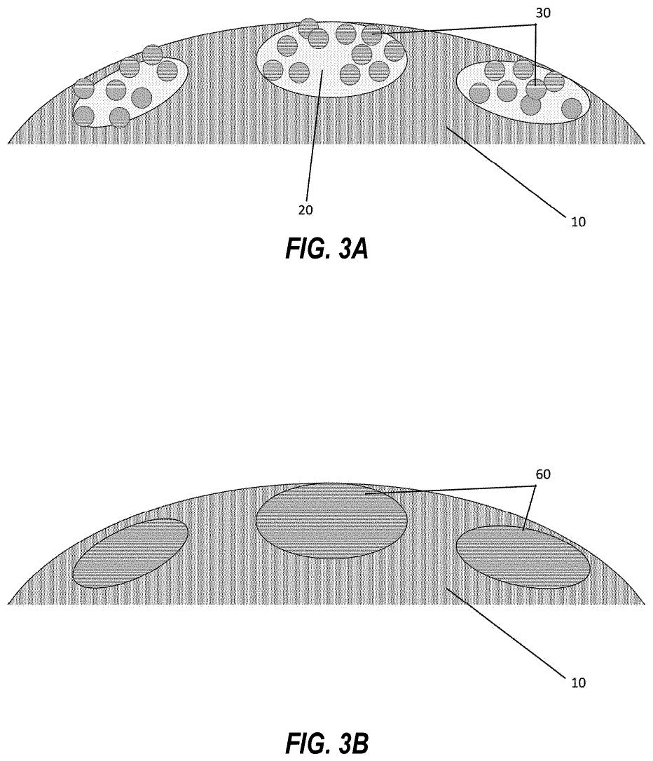

Embodiments of the present invention are based on solution-produced silica nano-coatings as shown in FIG. 2, preferably comprising nanoparticles 30 comprising hydrophilic tails 40, which preferably comprise functional groups F2, and reactive binder 50, which preferably comprises functional groups F1 which bind to functional groups F2 through a chemical reaction in solution. The chemically reacted binder binds the particles specifically to the hydrophobic siloxane regions of the lens, preferably via a physical interaction of the preferably silicone-based binder and silicone-based sections of the lens, as shown in FIG. 3A. The particles preferably coalesce together to form a substantially continuous coating 60 on the hydrophobic surfaces, as shown in FIG. 3B. The coatings of the present invention are preferably submicron in thickness, more preferably having a thickness between 50 and 500 nanometers, and are synthesized in solution, enabling the addition of modifiers to the finished solution-produced particles. The reaction of functional groups F2 such as epoxy moieties with the binder enables it to bind to the hydrophilic tails of the particles prior to deposition of the coating on the article surface. More specifically, the hydrophobic silicone-based binder selectively bonds to the hydrophobic silicone-based sections of the contact lens due to the unique interaction between the two compounds. Silicones, for example siloxanes, while often liquid are still high-molecular weight polymeric materials. As such, their interaction with other materials is not just governed by typical liquid-solid parameters like contact angle but also by the ability to undergo true adhesion with other silicone materials. This autoadhesion is typically governed by diffusion of polymeric chains across the interface and entanglement of chains in both materials. This imparts hydrophilic properties specifically to the hydrophobic siloxane surfaces, while leaving the hydrophilic hydrogel regions of the lens surface unmodified.

Embodiments of the present coatings preferably rely on the chemical similarity between solid polydimethylsiloxane resins incorporated into the contact lens and oligomeric liquid precursor siloxanes of the binder with functional groups. After binding to the nanoparticles, the siloxanes preferably deposit the nanoparticles only on the siloxane polymer portions of the lens and provide the anchoring force for the solution-produced coating. Liquid siloxanes are available with a wide variety of both terminal and perpendicular bound functional groups, including amino, hydroxyl, epoxy, hydride, vinyl, acrylate, and mercapto groups. Corresponding functional modifiers on metal alkoxide precursors used to form the nanoparticles include epoxy, carboxylic acid, vinyl, acrylate, and amino groups. The precursors preferably comprise one or more epoxy-carrying silicon alkoxides.

Silica nano-coatings can be produced by first hydrolyzing a mixture of the desired metal alkoxides, typically a silicon alkoxide, with an excess amount of water in a mildly acidic solution until partial or approximately full hydrolysis has occurred. By changing the pH of the solution to mildly basic, polymerization is promoted and nanoparticle growth is initiated and continued for varying times until a test sample, which is preferably spun-coated onto a substrate, has a contact angle of 20° or less. At this point the solution is neutralized to stabilize the growth process at the desired stage. The resulting nanoparticle sizes typically range from 10 to 200 nm, and the solution appears optically clear. Spun-coated test coatings typically show a thickness of 20-200 nm and are optically clear.

The major advantage of this synthesis method lies in the ease of application of the coatings on a variety of substrates. As all chemical processes of the present invention preferably occur in solution, high heat is not required to form the coatings. In some embodiments of the present invention, the formation of the coating is performed at ambient temperatures. This enables use on substrates that are typically incompatible with silica nano-coatings, like plastics, fabrics or other temperature sensitive materials.

To produce coatings on highly hydrophobic materials it is preferable to add a reactive binder in solution to produce a good bond between the hydrophobic substrate and the overlying hydrophilic coating. The reactive binder is typically chosen from materials comprising a chain that is hydrophobic or otherwise compatible with the substrate and a reactive moiety that binds to the hydrophilic tails on the nanoparticles. In embodiments of the present invention, the compatible chain preferably comprises a siloxane oligomer and a reactive moiety such as an amine (F1) which binds to the functional groups F2, which preferably comprises an epoxy based on 3-glycidylpropylsiloxane incorporated into the solution.

An enhanced bonding effect can be also achieved by adding reactive chains to the siloxane resin of the lens. These reactive chains preferably comprise either two identical groups capable of reacting with the hydrophilic particles, or one group capable of reacting with the hydrophilic particles and one group capable of reacting with the bulk resin functionalities. Either leads to the formation of reactive bonds on the surface of the lens, which then react with reactive groups on the hydrophilic particles to bond chemically to the lens surface. This effect can be achieved using the same functionalities described above.

Coatings made using the compositions disclosed above are preferably stable at room temperature in both phosphate-buffered saline (PBS) solution (at a typical pH of 7.3) and a Tris(hydroxymethyl)aminomethane buffered saline (TBS) solution. A mixture of Tris-HCl and its conjugate base, at pH 7.0 to 9.2, is typically used in biochemistry and molecular biology, due to its heat sensitive nature, as a constituent of buffer solutions and to maintain pH within a set range. TBS is preferably used for storage of contact lenses to avoid irritation of the eye when the lens is used due to solution remaining on the lens. The concentration of the TBS solution is preferably between approximately 10 to 500 mM, more preferably between approximately 25 to 250 mM, and even more preferably between approximately 50 to 60 mM. The solution preferably comprises at least one surfactant, such as a tetrafunctional block copolymer (which preferably terminates in primary hydroxyl groups), and at least one biopolymer composite, such as a cellulose derivative.

In commercial processing of lenses for customer use, the lenses are typically heated to autoclave temperatures of 121° C. in TBS in order to sterilize them prior to sale. The pH of the TBS solution is preferably within a useful range to prevent corneal damage, between approximately 6.5 to 9.0, more preferably between approximately 6.9 to 7.5, and even more preferably between approximately 7.0 to 7.3. Generally speaking, low pH environments prove beneficial to the survival of the coatings made using the compositions disclosed above. The pKₐ of the TBS solution advantageously decreases approximately 0.03 units per every increase in degree C. and returns to the initial pKₐ after achieving ambient temperature. The favorable decrease in pKₐ during heating prevents destruction of the coating of the present invention. To further prevent destruction of the coating, the pH of non-heat sensitive solutions are preferably lowered to a pH from approximately 1-7, more preferably between approximately 3-6.5, and even more preferably between approximately 3.5-4.5. Solutions that can be used in accordance with this embodiment of the present invention include but are not limited to low pH distilled water or low pH saline. Coatings of the present invention can withstand such heating at such lower pH.

Coatings of the present invention can be applied by various methods. The coating is preferably applied to a finished contact lens by dipping the wet lens into the coating solution and subsequently washing retained coating on the lens in an aqueous solution. As indicated above, autoadhesion of the hydrophobic silicone-based binder to the hydrophobic silicone-based surface portions of the contact lens occurs due to the unique interlinkage between the two, and results in a coating that does not need to undergo drying, evaporation or any type of chemical reaction or alteration once applied.

To integrate the application of coatings of the present invention into a commercial manufacturing process it is desirable to not add additional steps to the existing process. Current contact lens manufacture results in a dry lens which is subjected to a series of extraction, hydration, and rinsing steps. The coating solution of the present invention is preferably used in between two of these steps, most preferably after the last alcohol-based rinse step and prior to the aqueous media rinse step. Thus the coating is preferably applied during contact lens manufacture by addition of the coating solution to one of the solutions employed to hydrate and purify the newly molded lens.

Coating is achieved by preferably depositing in-mold and hydrating contact lenses into a coating bath for approximately 30 seconds. The length of time for the lenses to be in the coating bath is dependent on the manufacturing process and can last from 1 second to 24 hours. The coating bath is a bath comprising hydrophilic particles preferably comprising functional groups F2, which are preferably chemically reacted in solution prior to coating of the lens to functional groups F1 of a binder. Upon application of the coating solution to a contact lens, the hydrophobic binder autoadheres to the hydrophobic sections of the contact lens and the hydrophilic particles amalgamate over the hydrophobic surfaces of the lens to form a distinct coating. This amalgamation of hydrophilic nanoparticles imparts complete hydrophilic performance across the lens while preferably leaving the hydrogel regions on the lens unmodified. The in-mold and hydrated lenses, once coated, can proceed through the hydration process without the need for additional steps to evaporate the solvent, fortify, cure or modify the coating. The deposition of the coating of the present invention is a truly one-step process and is stabilized by the strong foundation of the siloxane-siloxane interaction of the hydrophobic silicone-based sections of a lens and the hydrophobic silicone-based binder reacted with the hydrophilic nanoparticles. This consequently renders surface modification or treatment unnecessary, pre or post application of the coating solution, to promote coating adhesion to the article.

Contact lenses are commonly produced by injecting resin into disposable lens molds followed by resin cure using thermal or radiative cure methods. In an alternative embodiment of the present invention, modified sol-gel coatings are applied to a mold for the production of contact lenses prior to molding or casting of the contact lens. In this embodiment, the hydrophobic silicone chains on the coating entangle with chains of the siloxane resin of the lens, leading to a more stable bond.

### EXAMPLES

### Example 1

A silica solution containing 80% hydrolyzed tetraethoxy silane and 20% hydrolyzed 3-glycidoxypropyltrimethoxysilane in an ethanol solution at 2% solids content, prepared according to the methodology disclosed herein, was blended with an equimolar amount of aminopropyl-terminated siloxane (1000 cSt), and allowed to react for 30 min. A commercially packed siloxane-containing contact lens was rinsed in DI water for 1 min, immersed into the modified nanogel solution for 1 min, transferred to a clean deionized water solution for 1 min, and then transferred to a buffer solution.

### Example 2

A siloxane-containing contact lens was immersed into an ethanol solution of poly (aminopropyl-methyl-co-dimethyl siloxane (120 cSt) for 1 min. A nanogel containing 90% hydrolyzed tetraethoxy silane and 10% hydrolyzed 3-glycidoxypropyltrimethoxysilane in an ethanol solution with 1% solids content is added in an equimolar amount to the aminopropyl group on the siloxane, and allowed to react for 5 min. The lens was then transferred to a clean deionized water solution for 1 min, and then transferred to a buffer solution.

### Example 3

A nanogel containing 90% hydrolyzed tetraethoxy silane and 10% hydrolyzed methacryloxpropyl trimethoxysilane in an ethanol solution at 2% solids content, prepared according to the methodology disclosed herein, was blended with an equimolar amount of methacryloxpropyl-terminated siloxane (70 cSt). A siloxane-containing contact lens was immersed into the modified nanogel solution for 1 min, transferred to a clean deionized water solution for 1 min, and then transferred to a solution containing 0.01% AIBN. The solution was irradiated with a medium pressure mercury lamp for 30 sec to crosslink the coating.

### Example 4

A nanogel containing 90% hydrolyzed tetraethoxy silane and 10% hydrolyzed methacryloxpropyl trimethoxysilane in an ethanol solution at 2% solids content, prepared according to the methodology disclosed herein, was blended with an equimolar amount of methacryloxpropyl-terminated siloxane (70 cSt). A siloxane-containing contact lens was immersed into the modified nanogel solution for 1 min, transferred to a clean deionized water solution for 1 min, and then transferred to a solution containing 0.01% AIBN. The solution was then heated to 120° C. for 30 min to crosslink the coating and sterilize the content.

### Example 5

A coated contact lens as prepared in Example 1 was heated to 120° C. for 30 minutes in 2.5 mL deionized (DI) water comprising 1 drop (1N) HCl. The measured contact angle did not change after heating.

### Example 6

A coated contact lens as prepared in Example 1 was heated to 120° C. for 30 minutes in 2.5 mL DI water comprising 5% NaCl and 1 drop (1N) HCl. The measured contact angle did not change after heating.

### Example 7

A coated contact lens as prepared in Example 1 was heated to 120° C. for 30 minutes in 2.5 ml 50 mmol TRIS buffer. The measured contact angle did not statistically change after heating.

### Example 8

A contact lens shape was produced by blending 1% aminopropoxy-terminated dimethoxysilane with a conventional siloxane resin, adding to a mold, and curing. The contact lens was then added to a nanogel containing 80% hydrolyzed tetraethoxy silane and 20% hydrolyzed 3-glycidoxypropyltrimethoxysilane in an ethanol solution at 2% solids content and allowed to react for 1 h, resulting in a hydrophilic contact lens.

### Example 9

A contact lens shape was produced by blending 1% aminopropoxy-dimethoxysilane-methacrylate with a conventional siloxane resin, adding to a mold, and curing. The contact lens was then added to a nanogel containing 80% hydrolyzed tetraethoxy silane and 20% hydrolyzed 3-glycidoxypropyltrimethoxysilane in an ethanol solution at 2% solids content and allowed to react for 1 h, resulting in a hydrophilic contact lens.

### Example 10

A freshly molded and cured contact lens shape was swelled in an ethanol-based nanoparticle solution as described in Example 1. The coated lens was washed twice with isopropanol, once with a 50:50 mixture of isopropanol and water, followed by deionized water, and transferred into a buffer solution.

### Example 11

A freshly molded and cured contact lens shape was swelled in isopropanol, rinsed with isopropanol, and then immersed into an isopropanol-based solution using the method described in Example 1. The coated lens was washed with a 50:50 mixture of isopropanol and water, followed by deionized water, and transferred into a buffer solution.

### Example 12

A nanogel containing 80% hydrolyzed tetraethoxy silane and 20% hydrolyzed 3-glycidoxypropyltrimethoxysilane in an ethanol solution at 2% solids content, prepared according to the methodology disclosed herein, was blended with an equimolar amount of aminopropyl-terminated siloxane (1000 cSt), and allowed to react for 30 min. The resulting solution was coated onto a contact lens mold and allowed to dry. Silicone resin was added to the mold and cured, resulting in a hydrophilic contact lens shape.

Note that in the specification and claims, “about” or “approximately” means within twenty percent (20%) of the numerical amount cited. As used herein, the singular forms “a,” “an,” and “the” include plural referents unless the context clearly dictates otherwise. Thus, for example, reference to “a functional group” refers to one or more functional groups, and reference to “the method” includes reference to equivalent steps and methods that would be understood and appreciated by those skilled in the art, and so forth.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method for coating an article whose surface comprises at least one hydrophobic region, the method comprising:
at least partially hydrolyzing an acidic solution of an alkoxide, a functional modifier, and water;
polymerizing the alkoxide to form hydrophilic nanoparticles incorporating the functional modifier;
adding a hydrophobic binder to the solution comprising the hydrophilic nanoparticles;
attaching hydrophobic tails comprising a hydrophobic binder to the functional modifier on the nanoparticles; and
adhering the hydrophobic binders attached to the nanoparticles to the at least one hydrophobic region;
wherein the method is performed in solution.

2. The method of claim 1 wherein the hydrophobic binder comprises a silicone.

3. The method of claim 2 wherein the silicone comprises a siloxane or a siloxane oligomer.

4. The method of claim 1 wherein the hydrophobic binder comprises one or more functional groups.

5. The method of claim 4 wherein the one or more functional groups are selected from the group consisting of a hydride, amino, amine, hydroxyl, epoxy, vinyl, acrylate, and mercapto group.

6. The method of claim 5 wherein the at least one hydrophobic binder comprises aminopropyl terminated siloxane.

7. The method of claim 6 wherein the aminopropyl terminated siloxane comprises aminopropyl terminated polydimethylsiloxane.

8. The method of claim 1 wherein the at least one hydrophobic region comprises a silicone.

9. The method of claim 8 wherein the silicone comprises a siloxane.

10. The method of claim 8 wherein the article comprises a silicone hydrogel contact lens.

11. The method of claim 10 comprising hydrating the silicone hydrogel contact lens prior to the adhering step.

12. The method of claim 1 wherein the alkoxide is a metal alkoxide or a silicon alkoxide.

13. The method of claim 12 wherein the alkoxide comprises tetraethoxysilane.

14. The method of claim 1 wherein the alkoxide is a precursor to the hydrophilic particles.

15. The method of claim 1 wherein the functional modifier is selected from the group consisting of epoxy, carboxylic acid, vinyl, acrylate, and amino group.

16. The method of claim 15 wherein the functional modifier comprises 3-glycidylpropylsiloxane, 3-glycidoxypropyltrimethoxysilane, or methacryloxpropyl trimethoxysilane.

17. The method of claim 1 wherein the polymerizing step comprises changing the pH of the acidic solution to basic.

18. The method of claim 1 comprising continuing the polymerizing step until a sample of the solution has a contact angle of 20° or less on a substrate.

19. The method of claim 1 further comprising neutralizing the solution after the polymerizing step.

20. The method of claim 1 further comprising coalescing the nanoparticles to form a substantially continuous coating on the at least one hydrophobic region.

21. The method of claim 20 wherein the coating has a thickness between approximately 20 nm and approximately 500 nm.

22. The method of claim 20 wherein the coating is sufficiently optically clear to be suitable as a coating for a contact lens.

23. The method of claim 1 wherein the nanoparticles do not adhere to regions of the surface of the article that are not hydrophobic.

24. The method of claim 1 wherein the hydrophilic nanoparticles are between about 10 nm and 200 nm in size.

25. The method of claim 1 wherein the solution comprises ethanol.

26. The method of claim 1 wherein the solution comprises 2% solids content before the adding step.

27. The method of claim 1 wherein the adhering step is performed at no higher than ambient temperature.

28. The method of claim 27 wherein the article would be destroyed if heated to a temperature above ambient temperature.

29. The method of claim 1 wherein the adhering step is performed from between approximately 1 second and approximately 24 hours.

30. The method of claim 29 wherein the adhering step is performed for approximately 30 seconds.

31. The method of claim 1 wherein the adhering step comprises diffusion of polymeric chains between the hydrophobic binder and the at least one hydrophobic region and entanglement of the chains.

32. The method of claim 1 further comprising washing the article in an aqueous solution after the adhering step.

33. The method of claim 1 further comprising storing the article in an acidic solution after the adhering step.

34. The method of claim 33 wherein the acidic solution comprises distilled water or saline.

35. The method of claim 33 wherein the coating remains substantially unmodified when heated to above ambient temperature in the acidic solution.

36. The method of claim 35 wherein the coating remains substantially unmodified when heated to about 120° C. in the acidic solution.

37. The method of claim 33 wherein a contact angle of the coating increases by less than approximately 5 degrees after heating in the acidic solution.
